(19) United States
(12) Patent Application Publication
(10) Pub. No.: US 2013/0196578 A1
(43) Pub. Date: Aug. 1, 2013

(54) DEVICE FOR MILLING AND POLISHING METHACRYLATE OR TRANSPARENT PLASTICS

(71) Applicant: Fermin Arias Sucarrats, Madrid (ES)

(72) Inventor: Fermin Arias Sucarrats, Madrid (ES)

(21) Appl. No.: 13/817,601

(22) PCT Filed: Aug. 4, 2011
(86) PCT No.: PCT/ES2011/070579

§ 371 Date: Apr. 11, 2013

(30) Foreign Application Priority Data
Aug. 17, 2010 (ES) P201031263

(51) Int. Cl. B23C 5/00

(52) U.S. Cl. CPC B23C 5/006
USPC 451/461

(57) ABSTRACT

The invention relates to a device for milling and polishing methacrylate, consisting essentially of a saw or milling blade (2) having multiple teeth that is integrally attached in an axial manner to a plate body (1) having the same diameter as the saw or milling blade (2) such that same acts as a support for said saw blade (2) and comprises an insert (3, 3′) having at least one diamond tip (31), which is located in a position near the outer perimeter of said saw blade (2); and wherein said insert (3, 3′) is anchored to the support plate (1) and externally enclosed by the saw blade (2), such that only the edge of the diamond tip (31) of the insert (3, 3′) protrudes with respect to the surface of the saw blade (2).

The object of the present patent is a device for milling and polishing methacrylate faces consisting of a plate acting as a support with a saw blade or milling blade having multiple teeth with the ability to rough cut methacrylate, in an axial manner, with a plurality of teeth and comprising a single insert with a diamond tip for the final finish.

### PRIOR STATE OF THE ART

Methacrylate must be polished once it has been cut because the cutting causes opacity on the face or edge that is touched.

Two types of polishing plates are described in the current state of the art, which plates are characterized in that they comprise a plurality of polycrystalline diamond (PCD) tool tips and provide better transparency quality and quick milling. On the other hand, the tip that does the trimming is usually made of natural diamond.

Therefore, in the state of the art there are tools in the form of a plate that usually have two welded tips opposite one another at 180°, wherein one of them produces the rough cutting which can reach a depth of about 3 mm, and the other produces a fine, transparent finish by touching only a few tenths, i.e., for each turn of the mill on the methacrylate one of them produces a rough cutting pass and the other one produces a finishing pass, leaving the methacrylate transparent as it advances on the machining line. This tool can be sharpened once it no longer cuts.

There are milling cutting tools with interchangeable tips with different finishing possibilities similar to the preceding one, where a total of four tool inserts can be chosen, some inserts for cutting and other inserts for polishing. Such milling plates do not have to be sharpened in their entirety, only the different tool inserts, which are easily detachable.

### BRIEF DESCRIPTION OF THE INVENTION

The device for cutting and polishing methacrylate object of the present patent combines a plate with a saw or milling blade having multiple teeth and an interchangeable diamond (PCD) tip, combining the features of these elements in the methacrylate milling cutting, achieving a rate of advance at a ratio of 4:1 with respect to other devices.

The device object of the patent consists essentially of a saw or milling blade having multiple teeth that is integrally attached to a plate body such that it acts as a support for said saw blade, and is characterized in that it comprises an insert having at least one diamond tip near the outer perimeter of said saw blade, and wherein said insert is anchored to the support plate and externally enclosed by the saw blade, such that only the edge of the diamond tip of the insert protrudes with respect to the surface of the saw blade.

The diamond tip can be made of natural diamond or polycrystalline diamond.

Throughout the description and claims the word “comprises” and its variants do not seek to exclude other technical features or components. For the persons skilled in the art, other objects, advantages and features of the invention will be apparent from the description and from the practice of the invention. The following examples and drawings are provided by way of illustration and are not meant to be limiting of the present invention. The present invention further covers all the possible combinations of particular and preferred embodiments herein indicated.

### BRIEF DESCRIPTION OF THE DRAWINGS

FIG. 1 shows a view of the device for milling and polishing methacrylate, object of the present invention.

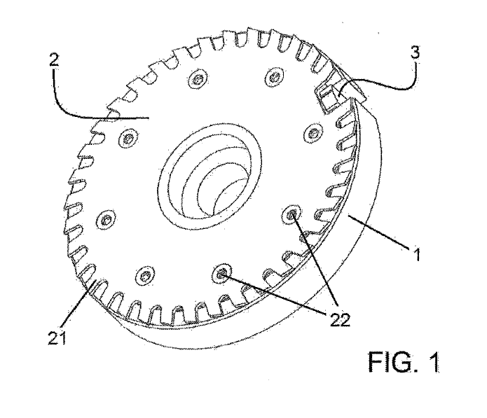

FIG. 2 shows an exploded view of the device for milling and polishing methacrylate, object of the present invention.

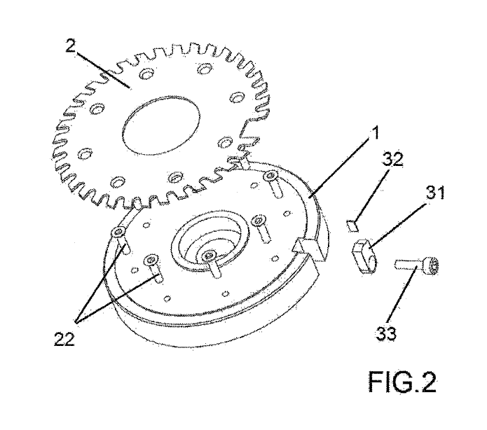

FIG. 3 shows a view of a second particular embodiment of the device for milling and polishing methacrylate, object of the present invention.

### DETAILED DESCRIPTION OF SEVERAL EMBODIMENTS

As observed in the attached drawings, the device for cutting and polishing methacrylate, object of the present invention patent consists essentially of a new or milling blade (2) having multiple teeth that is integrally attached in an axial manner to a plate body (1) having the same diameter, and acting as a support for said saw blade (2) or mill.

This saw or milling blade (2) consists of thirty-six cutting teeth (21) for the rough cutting of the methacrylate and is attached to the plate (1) by a plurality of screwed attachments (22), such that said saw blade (2) can be easily interchanged when it loses cutting capability due to use.

An insert (3) with a natural or polycrystalline diamond tip is arranged near the outer perimeter for performing the final finish. Said insert (3) is formed by a flat rectangular pellet (31) located in a portion of the edge of the support plate (1) and of the saw (2). Said flat rectangular part (31) comprises the diamond tip (32) at its upper part, such that only the edge of said diamond tip (32) protrudes with respect to the upper surface of the saw blade (2). The assembly is anchored to the support plate (1) by means of a screwed attachment.

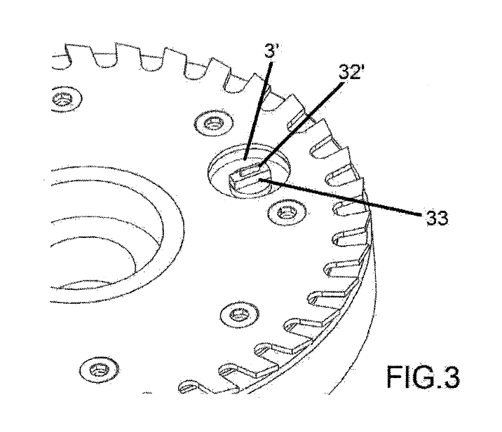

In a second practical embodiment of the insert (3), as shown in FIG. 3, said insert consists of a cylindrical insertion (3′) in the body of the support plate (1) near the crown of the mill or saw (2) such that, as in the other embodiment of the insert, only the edge of the diamond tip (32′) protrudes with respect to the upper surface of the saw blade (2), said diamond tip (32′) being held by a tool bit holder (33).

The position of the insert (3, 3′) near the outer perimeter of the saw blade (2), and therefore near the teeth (21) that define the cut or rough cut of the methacrylate allow the passage of the diamond tip (31) to polish said cut in a single pass while at the same time performing the cutting or rough cutting in normal use of the saw blade (2).

1. A device for milling and polishing methacrylate, consisting essentially of a saw or milling blade (2) having multiple teeth that is integrally attached in an axial manner to a plate body (1) having the same diameter as the saw or milling blade (2) such that same acts as a support for said saw blade (2), and characterized in that it comprises an insert (3, 3′) having at least one diamond tip (31), which is located in a position near the outer perimeter of said saw blade (2); and wherein said insert (3, 3′) is anchored to the support plate (1) and externally enclosed by the saw blade (2), such that only the edge of the diamond tip (31) of the insert (3, 3′) protrudes with respect to the surface of the saw blade (2).

2. The device according to claim 1, characterized in that the diamond tip (31) is made of natural diamond.

3. The device according to claim 1, characterized in that the diamond tip (31) is made of polycrystalline diamond.

4. The device according to claim 1, characterized in that the insert (3) is located in a portion of the outer crown of the plate (1)—saw (2) assembly and is formed by a flat rectangular pellet (31) comprising the diamond tip (32) at its upper part, such that the edge of said diamond tip (32) protrudes with respect to the upper surface of the saw blade (2).

5. The device according to claim 1, characterized in that the insert (3′) consists of a cylindrical insertion in the body of the support plate (1) near the crown of the mill or saw (2) such that the edge of the diamond tip (32′) protrudes with respect to the upper surface of the saw blade (2).

6. The device according claim 1, characterized in that the insert (3, 3′) is anchored to the support plate (1) by means of a screwed attachment.

7. The device according to claim 2, characterized in that the insert (3) is located in a portion of the outer crown of the plate (1)—saw (2) assembly and is formed by a flat rectangular pellet (31) comprising the diamond tip (32) at its upper part, such that the edge of said diamond tip (32) protrudes with respect to the upper surface of the saw blade (2).

8. The device according to claim 3, characterized in that the insert (3) is located in a portion of the outer crown of the plate (1)—saw (2) assembly and is formed by a flat rectangular pellet (31) comprising the diamond tip (32) at its upper part, such that the edge of said diamond tip (32) protrudes with respect to the upper surface of the saw blade (2).

9. The device according to claim 2, characterized in that the insert (3′) consists of a cylindrical insertion in the body of the support plate (1) near the crown of the mill or saw (2) such that the edge of the diamond tip (32′) protrudes with respect to the upper surface of the saw blade (2).

10. The device according to claim 3, characterized in that the insert (3′) consists of a cylindrical insertion in the body of the support plate (1) near the crown of the mill or saw (2) such that the edge of the diamond tip (32′) protrudes with respect to the upper surface of the saw blade (2).

11. The device according claim 2, characterized in that the insert (3, 3′) is anchored to the support plate (1) by means of a screwed attachment.

12. The device according claim 3, characterized in that the insert (3, 3′) is anchored to the support plate (1) by means of a screwed attachment.

13. The device according claim 4, characterized in that the insert (3, 3′) is anchored to the support plate (1) by means of a screwed attachment.

14. The device according claim 5, characterized in that the insert (3, 3′) is anchored to the support plate (1) by means of a screwed attachment.

15. The device according claim 9, characterized in that the insert (3, 3′) is anchored to the support plate (1) by means of a screwed attachment.
